(19) United States
(12) Patent Application Publication
(10) Pub. No.: US 2021/0267294 A1
(43) Pub. Date: Sep. 2, 2021

(54) GARMENT

(71) Applicant: un. deux Co., Ltd., Okayama-shi, Okayama (JP)

(72) Inventor: Jiro NAKAMURA, Okayama-shi, Okayama (JP)

(21) Appl. No.: 17/258,627

(22) PCT Filed: Jun. 12, 2019
(86) PCT No.: PCT/JP2019/023314

§ 371 Date: Jan. 7, 2021

(30) Foreign Application Priority Data
Jul. 18, 2018 (JP) 2018-135328

(51) Int. Cl. A41D 31/18; A41D 31/10

(52) U.S. Cl. CPC A41D 31/185; A41D 31/10

(57) ABSTRACT

[Technical Problem] Provided is a garment having a soft and stretchable cloth, in which while the garment includes a windproof sheet, a napped fabric, and an outer fabric, increase in thickness of the cloth is prevented. [Solution to Problem] The garment includes a stretchable outer fabric, a lining fabric, and a windproof sheet disposed between the outer fabric and the lining fabric. The windproof sheet is an elastic film having a thickness of 13 μm or less and having windproof performance. The lining fabric includes a stretchable base fabric and a nap on the base fabric, and the nap has a length of pile of 4.0 mm or less.

### FIELD

The present invention relates to a garment including a stretchable fabric, a lining fabric, and a windproof sheet disposed between the outer fabric and the lining fabric.

### BACKGROUND

A garment including a windproof sheet affixed to the back surface of a cloth for the purpose of improving cold protection performance is known.

For example, Patent Literature 1 describes a laminated fabric for jeans, in which a soft polyurethane film is affixed to the back surface of a denim base fabric with a polyurethane-based adhesive, and a lining fabric is temporarily attached to the back of the film with a water-soluble adhesive and stitched together.

For example, Patent Literature 2 describes a thermal and moisture-permeable waterproof fabric constructed by bonding a film containing a water-swelling urethane resin to a cloth with a moisture-curable hot-melt resin.

### CITATION LIST

### Patent Literature

Patent Literature 1: Japanese Patent Application Laid-open No. H5-31854

Patent Literature 2: Japanese Patent Application Laid-open No. 2002-370335

### SUMMARY

### Technical Problem

Patent Literature 1 describes improvement of cold protection performance by providing nap in the inside of the cloth. Some type of lining fabric is presumably affixed to the thermal and moisture-permeable waterproof fabric in Patent Literature 2 to be used, because the film is easily broken when the film is exposed. In the laminated fabric for jeans in Patent Literature 1, a soft polyurethane film is affixed to a denim base fabric to impart wind-proof performance. In the thermal and moisture-permeable waterproof fabric in Patent Literature 2, a water-swelling moisture-permeable polyurethane film is affixed to a base fabric to impart moisture-permeability, waterproofness, and a heat retention property.

As described above, in the fabric including a film affixed on the back surface of a fabric, the thickness of the cloth is increased because of the film. When a napped layer is provided on the back surface of the cloth, the thickness of the cloth further increases. The garment sewed from such a cloth may be uncomfortable.

An object of the present invention is to provide a garment including a soft and stretchable cloth, in which while the garment includes a windproof sheet, a napped fabric, and an outer fabric, increase in thickness of the cloth is prevented.

### Solution to Problem

The problem above is solved by a garment including a stretchable fabric, a lining fabric, and a windproof sheet disposed between the outer fabric and the lining fabric, in which the windproof sheet is an elastic film having a thickness of 13 μm or less and having windproof performance, the lining fabric includes a stretchable base fabric and a nap on the base fabric, and the nap has a length of pile of 4.0 mm or less.

In the garment described above, it is preferable that, the lining fabric includes compound yarn, the compound yarn includes base yarn and yarn for nap, the yarn for nap is constructed from a plurality of fibers, the yarn for nap is in a napped state, the degree of fineness of the base yarn is 58 denier or less. In the garment described above, it is preferable that, the lining fabric includes compound yarn, the compound yarn includes base yarn and yarn for nap, the yarn for nap is constructed from a plurality of fibers, the number of fibers that construct the yarn for nap is 150 or more, the yarn for nap is in a napped state. It is preferable that a ratio of a mass of the nap to a mass of the lining fabric is 50 mass' or more. It is preferable that a ratio obtained by dividing a thickness of the nap by a thickness of the base fabric is 15% or less. It is preferable that the outer fabric and the windproof sheet or the lining fabric and the windproof sheet are bonded with a hot-melt adhesive containing a urethane resin that is moisture-curable.

### Advantageous Effects of Invention

The present invention can provide a garment including a soft and stretchable cloth, in which while the garment includes a windproof sheet, a napped fabric, and an outer fabric, increase in thickness of the cloth is prevented.

### BRIEF DESCRIPTION OF DRAWINGS

FIG. 1 is an exploded perspective view illustrating an example of a cloth for use for sewing a garment.

FIG. 2 is a diagram illustrating an example of the construction of a lining fabric.

FIG. 3 is a diagram illustrating an example of yarn having yarn for nap wound around base yarn.

### DESCRIPTION OF EMBODIMENTS

An embodiment for carrying out the invention will be described below.

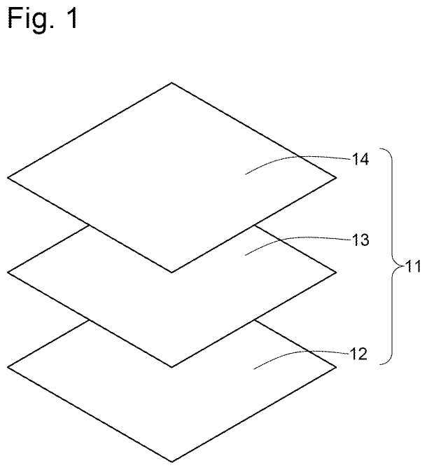

FIG. 1 schematically illustrates a construction of a cloth for use for sewing a garment of the present embodiment. As illustrated in FIG. 1, this cloth 11 includes a stretchable outer fabric 14, a lining fabric 12 disposed on the side in contact with the body of a wearer, and a windproof sheet 13 disposed between the outer fabric 14 and the lining fabric 12.

The windproof sheet 13 can prevent blowing wind from passing through the cloth 11 when a garment is constructed with the cloth 11, and a film having elasticity with a thickness of 13 μm or less can be used. The lower limit value of the thickness of the windproof sheet is greater than 0 μm and, for example, the windproof sheet of 1.0 μm or more is easy to shape. More preferably, the windproof sheet is 9.0 μm or less.

It is preferable that the windproof sheet 13 is, for example, the one constructed from a thermoplastic elastomer, because it is easily shaped into a sheet and has elasticity. Examples of the thermoplastic elastomer include polyurethane-based synthetic resins having a soft segment and a hard segment and having both shaping characteristics of plastics and elasticity of rubber.

It is preferable that the windproof sheet 13 has permeability to water vapor in terms of preventing sweatiness when the garment is worn. A porous film having minute through holes can impart permeability to water vapor but impairs windproof performance. In order to impart permeability to water vapor, it is preferable that the windproof sheet 13 is constructed with a non-porous hydrophilic material. When the windproof sheet 13 is constructed with a hydrophilic material, the windproof sheet 13 absorbs moisture and achieves moisture permeability by evaporating a liquid component soaked in the windproof sheet 13.

The outer fabric 14 may be any stretchable fabric. Examples of the outer fabric include knitted fabrics or clothes such as woven and stretchable knitted fabrics formed by stretchable yarn such as spandex yarn.

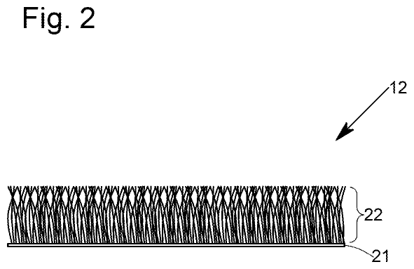

For example, as illustrated in FIG. 2, the lining fabric 12 includes a stretchable base fabric 24 and a nap 22 on the base fabric 24 and having a length of pile of 4.0 mm or less. The base fabric is, for example, constructed from a knitted fabric or constructed from a knitted fabric or a woven fabric with stretchable yarn such as spandex yarn so that stretch-ability is imparted to the base fabric. A base end portion of the nap is connected to the base fabric, and one end portion of the nap is a free end.

It is preferable that the lining fabric 12 is constructed with compound yarn of base yarn and yarn for nap constructed from a plurality of fibers. For example, stretchable yarn such as spandex yarn can be used as the base yarn constructing the base fabric to impart stretch-ability to the lining fabric 12, or a stretchable cloth such as a knitted fabric can be constructed with the base yarn to impart stretch-ability to the base fabric. Stretchable yarn may be used as the base yarn, and a stretchable cloth such as a knitted fabric may be constructed with this base yarn to impart further stretch-ability to the base fabric.

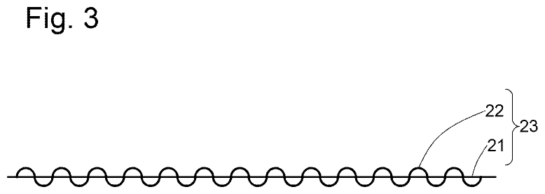

The lining fabric 12 can be constructed with compound yarn of base yarn and yarn for nap such that, for example, yarn excellent in stretch-ability or tensile strength is used for the base yarn while yarn excellent in wear resistance is used for yarn for nap. For example, as illustrated in FIG. 3, a lining fabric including the base yarn 21 and the yarn for nap 22 can be obtained by weaving or knitting the base fabric 24 with yarn 23 having yarn for nap 22 wound around base yarn 21.

When the base yarn 21 is used, the base yarn 21 constructs a base fabric serving as a base for nap. The base yarn 21 of 58 denier or less is preferably used. By using such fine base yarn, the thickness of the base fabric and the proportion of the weight of the base yarn to the weight of the lining fabric can be reduced. The lower limit value of the degree of fineness of the base yarn 21 is preferably, but not limited to, 10 denier or more. The base yarn is more preferably 40 denier or less, and more preferably 32 denier or less.

When the yarn for nap 22 is used, the yarn for nap 22 is in a napped state on the base of the base yarn 21, as illustrated in FIG. 2. To nap the surface, for example, friction is applied to a surface of the lining fabric to nap the yarn for nap 22 wound around the base yarn 21. The length of pile of the nap 22 is 4.0 mm or less in a napped state. The thickness of the lining fabric thus can be reduced. The length of pile refers to the length from the base end to the tip end of nap. The length of pile is more preferably 2.5 mm or less, and more preferably 1.8 mm or less. The lower limit value of the length of pile is preferably, for example, 0.5 mm or more. The length of pile can be adjusted, for example, by napping fibers that construct the yarn for nap and thereafter trimming the nap.

When the pile of the nap is short, the thickness of the lining fabric can be reduced. However, short piles may deteriorate feel, texture, and heat retention of the cloth. It is therefore preferable that the number of fibers that construct the yarn for nap is 150 or more. With this configuration, the thickness of fibers that construct the yarn for nap can be thin, and smooth and soft feel when the nap is touched can be imparted to the lining fabric. In addition, this configuration can increase the density of the nap to make the nap shiny and impart fancy texture to the lining fabric. The number of fibers that construct the yarn for nap is more preferably 180 to 300.

As described above, when the base yarn 21 is used, it is preferable that the degree of fineness of the base yarn 21 is 58 denier or less and that the thickness of the base yarn is thin. When the thickness of the lining fabric is uniform, reducing the thickness of the base yarn 21 reduces the thickness of the base fabric 24 and can increase the amount of nap 22 accordingly. For example, the ratio of the mass of nap to the mass of the lining fabric may be 50 mass % or more. Thus, the amount of nap can be increased without increasing the thickness of the lining fabric, thereby improving heat retention, feel, and texture of the cloth. The ratio above is more preferably 60 mass %, or more, and further preferably 88 mass % or more. The upper limit is preferably 99 mass % or less.

As described above, when the base yarn 21 is used for the lining fabric, it is preferable that the degree of fineness of the base yarn is 58 denier or less and that the thickness of the base yarn is thin. In this case, since the thickness of the base yarn 21 is thin, for example, the ratio obtained by dividing the value of the thickness of nap by the value of the thickness of the base fabric constructed from the base yarn 21 and multiplying this by 100 can be 15% or less. With this configuration, the length of pile can be maximized while the thickness of the lining fabric is minimized, thereby improving heat retention, feel, and texture of the cloth.

The base fabric 24 constructed from the base yarn 21 is preferably constructed from a warp-knitted fabric. A warp-knitted fabric can impart stretch-ability to the lining fabric. With this configuration, when worn, the garment is easy to move in, in spite of a napped fabric constructed by laminating the outer fabric and the lining fabric. A warp-knitted fabric has a denser structure than a flat-knitted fabric. Thus, the density of nap can be increased by constructing the napped fabric with a warp-knitted fabric and napping the yarn for nap. With this configuration, although the piles of nap are shorter, the feel of the lining fabric can be smooth.

When a flat-knitted fabric is damaged, yarn ravels limitlessly, and ultimately the fabric is broken. In the case of a warp-knitted fabric, even if the lining fabric of the napped fabric is damaged, limitless raveling of yarn can be prevented. With this configuration, the durability of the napped fabric can be improved.

The base yarn can be constructed from, for example, one kind of synthetic fibers selected from the group consisting of polyester, nylon, acrylic, and polyurethane fibers, or natural fibers selected from the group consisting of cotton, wool, and silk fibers.

The yarn for nap can be constructed from, for example, one kind of synthetic fibers selected from the group consisting of polyester, nylon, and acrylic fibers, or natural fibers selected from the group consisting of cotton, wool, and silk fibers. Among those, polyester is preferably used because if so, pilling is less likely to occur in napping and fibers are less likely to be shredded. The degree of fineness of the yarn for nap is preferably 40 to 98 denier, more preferably 50 to 80 denier, and particularly preferably 60 to 75 denier.

The cloth 11 constructed with the outer fabric 14, the windproof sheet 13, and the lining fabric 12 described above can be sewn by a known method to construct an upper wear, a lower wear, or a garment that is an integrated combination of an upper wear and a lower wear, such as dresses and overalls. The napped fabric in the present embodiment is a laminated cloth including an outer fabric and a lining fabric superimposed on each other, but is not stiff in sewing and easy to sew because of a small thickness.

The cloth that constructs the garment has an elongation ratio of 40- or more obtained in accordance with JIS L 1096 Method B. The upper limit of the elongation ratio is preferably, but not limited to, 100% or less.

### EXAMPLES

A specific description will be given below with examples.

### Example 1

A 75-denier polyester multifilament yarn (the number of filaments of 288) as the yarn for nap was wound around the base yarn constructed with a 30-denier polyurethane monofilament (spandex yarn). The thus obtained compound yarn was knitted using a knitting machine into a warp-knitted fabric.

The surface of the warp-knitted fabric underwent a napping process of applying friction, and the nap was cut such that the length of pile was 1.5 mm, resulting in a napped lining fabric. When the napping process was applied to the base yarn, the friction force was adjusted so that the warp-knitted fabric was not broken.

A denim fabric made of a twill structure was obtained using cotton yarn dyed with indigo as warp yarn and using elastic yarn including stretchable polyurethane fibers and cotton fibers as weft yarn. This denim fabric was used as the outer fabric, and a hydrophilic and non-porous polyurethane film (JIAXING NANXIONG POLYMER CO., LTD., product number DTTM008) having a thickness of 8.0 μm was affixed as the windproof sheet to the back surface of the denim fabric. The lining fabric obtained above was affixed to the back surface of the polyurethane film. When the polyurethane film and the denim fabric were bonded, a polyurethane adhesive (manufactured by ZHEJIANG DUOBANG CHEMICAL CO., LTD., product number DB-2757) was used. When the polyurethane film (JIAXING NANXIONG POLYMER CO., LTD., product number DTTM008) and the lining fabric were bonded, a polyurethane adhesive (manufactured by ZHEJIANG DUOBANG CHEMICAL CO., LTD., product number DB-2757) was used similarly.

Denim pants were sewn using the denim fabric in a three-layer structure obtained by the production method above. Using them, evaluation was conducted for the items listed in Table 1. Flexibility and stretchiness were evaluated by sensory evaluation. For the elongation ratio and the elongation recovery ratio, the elongation ratio and the elongation recovery ratio in the crosswise direction were measured in accordance with JIS L 1096 Method B. The results are listed in Table 1.

### Example 2

Denim pants were fabricated in the same manner as in Example 1 except that the denim fabric and the polyurethane film as well as the polyurethane film and the lining fabric were affixed using a moisture-curable polyurethane hot-melt adhesive (SHANGHAI ANNEL CHEMICAL NEW MATERIALS CO., LTD., product number AM9600), instead of the polyurethane adhesive (manufactured by ZHEJIANG DUOBANG CHEMICAL CO., LTD., product number DB-2757) used in Example 1. For the fabricated denim pants, the physical properties listed in Table 1 and the feel, texture, and heat retention of the lining fabric were evaluated in the same manner as described above. The results are listed in Table 1.

### Comparative Example 1

Denim pants were fabricated in the same manner as in Example 2 except that the windproof sheet was changed to a polyurethane film commercially available from Zhongshan Breathtex Speciality Material Co., Ltd. with a thickness of 40 μm. For the fabricated denim pants, the physical properties and the like listed in Table 1 were evaluated in the same manner as described above. The results are listed in Table 1.

### Comparative Example 2

Denim pants were fabricated in the same manner as in Example 1 except that the windproof sheet was changed to a polyurethane film from Zhongshan Breathtex Speciality Material Co., Ltd. with a thickness of 40 μm. For the fabricated denim pants, the physical properties and the like listed in Table 1 were evaluated in the same manner as described above. The results are listed in Table 1.

### Comparative Example 3

Denim pants were fabricated in the same manner as in Example 1 except that the windproof sheet was changed to a polyurethane film commercially available from Zhongshan Breathtex Speciality Material Co., Ltd. with a thickness of 40 μm, and that the lining fabric with base yarn with a degree of fineness of 60 denier, with a length of pile of 6.0 mm, and using 75-denier polyester multifilament yarn (the number of filaments of 100) as yarn for nap was used. For these denim pants, the physical properties and the like listed in Table 1 were evaluated in the same manner as described above. The results are listed in Table 1.

TABLE 1

| | Elonga- | Recovery | Recovery | | |
|---|---|---|---|---|---|
| | tion | ratio | ratio | | |
| | ratio | (after 30 | (after | Flexi- | |
| | (%) | seconds) | an hour) | bility | Stretchiness |
| Example 1 | 40.5 | 57.0 | 72.7 | ◯ | ◯ |
| Example 2 | 45.8 | 52.6 | 69.4 | ⊙ | ⊙ |
| Comparative | 39.8 | 56.4 | 74.0 | Δ | X |
| Example 1 | | | | | |
| Comparative | 28.0 | 62.9 | 80.3 | X | X |
| Example 2 | | | | | |
| Comparative | — | — | — | X | X |
| Example 3 | | | | | |

The flexibility in Table 1 indicates softness of the cloth of the denim pants kneaded by hand. Among double circle, circle, triangle, and cross mark, the one mentioned earlier indicates that the cloth felt softer and was easily bent by the force applied, and the one mentioned later indicates that the cloth felt hard and was bent with more difficulty.

The stretchiness in Table 1 represents the amount of elongation and the resistance to elongation when the cloth of the denim pants is pulled in the crosswise direction of the cloth, that is, the width direction of the denim pants. Among double circle, circle, and cross mark, the one mentioned earlier indicates that the amount of elongation is large and that the resistance to elongation is small, and the one mentioned later indicates that the amount of elongation is small and that the resistance to elongation is large.

As listed in Table 1, the denim pants in Example 2 were most excellent in flexibility, stretchiness, and elongation ratio. In the denim pants of Examples 1 and 2, the elongation ratio was 40% or more in spite of provision of the windproof sheet. The denim pants in Example 1 was next most excellent in flexibility, stretchiness, and elongation ratio. The denim pants in Example 1 and Example 2 were comparable in appearance to normal denim pants and did not look bulky but looked slim. In the denim pants in Example 1 and Example 2, the density of napped fibers in the lining fabric was high, the denim pants had a special shiny texture due to reflection of light by fine fibers, and the lining fabric had a powder-touch smooth feel. The denim pants in Example 1 and Example 2 were also excellent in heat retention.

The denim pants in Comparative Example 1 and Comparative Example 2 were inferior to those in Example 1 and Example 2 in flexibility, stretchiness, and elongation ratio. The denim pants in Comparative Example 3 were still inferior to those in Comparative Example 2 in stretchiness and flexibility, and the elongation ratio thereof was not measured. In the denim pants in Comparative Example 3, since the base yarn was relatively thick and the piles were relatively long, the appearance of the denim pants looked expanded and bulky, compared with normal denim pants. In the denim pants in Comparative Example 3, the density of napped fibers in the lining fabric was low, the surface of the lining fabric felt rough, the texture was not shiny unlike Example 1, and the heat retention was also inferior to that of the denim pants in Example 1 and Example 2.

In the denim pants in Example 1 and Example 2, the ratio of the mass of the yarn for nap to the mass of the lining fabric was 90 mass %. The ratio of the mass of the yarn for nap to the mass of the lining fabric was determined by the following equation.

Y=[A÷(A+B)]×100

where Y is the ratio (mass-) of the mass of the yarn for nap to the mass of the lining fabric,
A is the mass (g) of the yarn for nap, and
B is the mass (g) of the base yarn.

In the denim pants in Example 1 and Example 2, the ratio obtained by dividing the value of the thickness (the thickness of the layer of napped yarn) of the napped yarn for nap by the value of the thickness of the base fabric constructed from the base yarn and multiplying by 100 was 5%.

In the denim pants in Example 1 and Example 2, the napped yarn for nap made up a large part of the lining fabric, the base fabric was constructed with a small amount of base yarn, and all of the items including heat retention of the lining fabric, feel of the lining fabric, and texture of the lining fabric were excellent.

### REFERENCE SIGNS LIST

11 cloth
12 lining fabric
13 windproof sheet
14 outer fabric

1. A garment comprising:
a stretchable outer fabric;
a lining fabric; and
a windproof sheet disposed between the outer fabric and the lining fabric, wherein
the windproof sheet is an elastic film having a thickness of 13 μm or less and having windproof performance, and
the lining fabric includes a stretchable base fabric and a nap on the base fabric, the nap having a length of pile of 4.0 mm or less.

2. The garment according to claim 1, wherein
the lining fabric includes compound yarn, the compound yarn includes base yarn and yarn for nap, the yarn for nap is constructed from a plurality of fibers,
the yarn for nap is in a napped state, and
the degree of fineness of the base yarn is 58 denier or less.

3. The garment according to claim 1, wherein
the lining fabric includes compound yarn, the compound yarn includes base yarn and yarn for nap, the yarn for nap is constructed from a plurality of fibers,
the number of fibers that construct the yarn for nap is 150 or more, and
the yarn for nap is in a napped state.

4. The garment according to claim 1, wherein a ratio of a mass of the nap to a mass of the lining fabric is 50 mass % or more.

5. The garment according to claim 1, wherein a ratio obtained by dividing a thickness of the base fabric by a thickness of the nap is 15% or less.

6. The garment according to claim 1, wherein the outer fabric and the windproof sheet or the lining fabric and the windproof sheet are bonded with a hot-melt adhesive containing a urethane resin that is moisture-curable.
